(19) United States
(12) Patent Application Publication
(10) Pub. No.: US 2005/0156441 A1
(43) Pub. Date: Jul. 21, 2005

(54) Door lock

(75) Inventor: Hung-Cheng Tsai, Chia-Yi City (TW)

Correspondence Address: DARBY & DARBY P.C., P. O. BOX 5257, NEW YORK, NY, 10150-5257, US

(73) Assignee: EZ TREND TECHNOLOGY CO., LTD., Chia-Yi County (TW)

(21) Appl. No.: 10/806,804

(22) Filed: Mar. 23, 2004

(30) Foreign Application Priority Data
Jan. 20, 2004 (TW) 093201215

(51) Int. Cl. E05C 3/06

(52) U.S. Cl. 292/336.3

(57) ABSTRACT

A door lock for a door panel includes a coupler and a door handle. The coupler is mounted rotatably on the door panel and is capable of driving rotation of an operating spindle between first and second angular positions for moving a latch bolt between latching and unlatching positions, respectively. The door handle includes a handle sleeve that is sleeved fittingly and removably on the coupler, and a lever that extends outwardly and radially from the handle sleeve. The lever extends sidewardly when the operating spindle is at the first angular position, and is operable so as to rotate the door handle downwardly such that the coupler drives rotation of the operating spindle from the first angular position to the second angular position.

### BACKGROUND OF THE INVENTION

1. Field of the Invention

The invention relates to a door lock, more particularly to a door lock with a removable door handle.

2. Description of the Related Art

A conventional door lock 1 for a door panel 91 is shown in FIGS. 1 and 2. The conventional door lock 1 includes a lock housing 12, a latch bolt 8 (see FIG. 2), an operating spindle 7, a door handle 13, and a restoring mechanism.

The lock housing 12 is mounted on the door panel 91, and includes a first wall 121 that has inner and outer wall surfaces, and a second wall 126 that extends from a periphery of the first wall 121, that surrounds the inner wall surface of the first wall 121, and that cooperates with the first wall 121 to define a mounting space. The first wall 121 of the lock housing 12 has left and right end portions (L, R), and a middle portion (M) that is disposed between the left and right end portions (L, R) and that is formed with a mounting hole 122 through the inner and outer wall surfaces. Each of the left and right end portions (L, R) of the first wall 121 of the lock housing 12 is formed with a fastener hole 128 (see FIG. 3) through the inner and outer wall surfaces. Left and right screw hole-defining walls 124, 123, each of which is disposed in the mounting space, extend from the inner wall surface of the first wall 121, and respectively define a screw hole that is aligned with a corresponding one of the fastener holes 128. A pair of screw fasteners 11, each of which is inserted through a respective one of the fastener holes 128 and a respective one of the screw holes, are threaded into the door panel 91.

The latch bolt 8 is mounted on the door panel 91, and is operable for movement between a latching position, where the latch bolt 8 is extended relative to the door panel 91, and an unlatching position, where the latch bolt 8 is retracted relative to the door panel 91.

The operating spindle 7 is coupled to the latch bolt 8, and is rotatable between a first angular position, where the latch bolt 8 is at the latching position, and a second angular position, where the latch bolt 8 is at the unlatching position.

The door handle 13 is mounted rotatably on the lock housing 12, and is capable of driving rotation of the operating spindle 7 between the first and second angular positions. The door handle 13 includes a shaft portion 131 that has an inner section and an outer section opposite to the inner section. The inner section of the shaft portion 131 is extended into the mounting space of the lock housing 12 through the mounting hole 122, and is coupled to the operating spindle 7. The outer section of the shaft portion 131 is disposed externally of the lock housing 12. The door handle 13 further includes a lever 132 that extends outwardly and radially from the outer section of the shaft portion 131.

The restoring mechanism serves to bias the door handle 13 to rotate the operating spindle 7 from the second angular position to the first angular position. The restoring mechanism includes a torsion spring 14 that has a coil portion 141, and a pair of opposite spring ends 143, 142. The torsion spring 14 is mounted in the lock housing 12 such that the coil portion 141 is sleeved on the inner section of the shaft portion 131 of the door handle 13 and abuts against the inner wall surface of the first wall 121, and such that the spring ends 143, 142 are respectively disposed under the left and right screw hole-defining walls 124, 123. The door handle 13 further includes an actuating ring 15 that has a ring portion 151, and a pair of diametrically opposite arms 153, 152. The actuating ring 15 is mounted in the mounting space of the lock housing 12 such that the ring portion 151 is sleeved securely and co-rotatably on the inner section of the shaft portion 131 of the door handle 13 and abuts against the torsion spring 14, and such that the arms 153, 152 are respectively disposed above the spring ends 143, 142 of the torsion spring 14. The inner section of the shaft portion 131 of the door handle 13 is formed with an annular groove. The restoring mechanism further includes a snap ring 16 that is fitted in the annular groove so as to retain the torsion spring 14 and the actuating ring 15 on the inner section of the shaft portion 131 of the door handle 13.

In use, as illustrated in FIG. 3, when the door lock 1 is mounted on the right side of the door panel 91, the lever 132 extends leftwardly when the operating spindle 7 is at the first angular position. At this time, the lever 132 is operable so as to rotate the door handle 13 downwardly relative to the lock housing 12 such that the shaft portion 131 drives rotation of the operating spindle 7 from the first angular position to the second angular position. During operation, the spring end 142 of the torsion spring 14 acts on the right screw hole-defining wall 123 of the lock housing 2, and the spring end 143 of the torsion spring 14 is acted upon by the arm 153 of the actuating ring 15.

Although the conventional door lock 1 achieves its intended purpose, when it is desired for the conventional door lock 1 that is configured for the right side of the door panel 91 to be mounted on the left side of the door panel 91, the door lock 1 has to be turned 180 degrees such that the lever 132 extends rightwardly when the operating spindle 7 is at the first angular position. As a consequence, the lever 132, at this time, is operable so as to rotate the door handle 13 upwardly relative to the lock housing 12 such that the shaft portion 131 drives rotation of the operating spindle 7 from the first angular position to the second angular position. Such operation of the lever 132 is undesirable in view of accustomed operation of a door handle.

In order to obviate such a drawback, the restoring mechanism has to be first re-assembled such that the spring ends 142, 143 of the torsion spring 14 are respectively disposed below the left and right screw hole-defining walls 124, 123, and such that the arms 152, 153 of the actuating ring 15 are respectively disposed above the spring ends 142, 143. This however causes a great deal of inconvenience on the part of the user.

### SUMMARY OF THE INVENTION

Therefore, the object of the present invention is to provide a door lock that can overcome the aforesaid drawback of the prior art.

According to the present invention, a door lock for a door panel comprises a lock housing, a latch bolt, an operating spindle, a coupler, a restoring mechanism, a door handle, fastening means, and a tongue-and-groove arrangement. The lock housing is adapted to be mounted on the door panel, and is formed with a mounting hole that has a hole axis. The latch bolt is adapted to be mounted on the door panel, and is operable for movement between a latching position, where the latch bolt is extended relative to the door panel, and an unlatching position, where the latch bolt is retracted relative to the door panel. The operating spindle is coupled to the latch bolt, and is rotatable between a first angular position, where the latch bolt is at the latching position, and a second angular position, where the latch bolt is at the unlatching position. The coupler is mounted rotatably on the lock housing, and includes a first coupling portion that extends into the lock housing through the mounting hole and that is coupled to the latch bolt, and a second coupling portion that is opposite to the first coupling portion and that is disposed externally of the lock housing. The coupler is capable of driving rotation of the operating spindle between the first and second angular positions. The restoring mechanism serves to bias the coupler to rotate the operating spindle from the second angular position to the first angular position. The restoring mechanism includes a torsion spring mounted in the lock housing, and having a first spring end acting on the lock housing, and a second spring end acted upon by the first coupling portion of the coupler. The door handle includes a handle sleeve that is sleeved fittingly and removably on the second coupling portion of the coupler, and a lever that extends outwardly and radially from the handle sleeve. The lever extends sidewardly when the operating spindle is at the first angular position, and is operable so as to rotate the door handle downwardly relative to the lock housing such that the coupler drives rotation of the operating spindle from the first angular position to the second angular position. The fastening means fastens removably the handle sleeve of the door handle on the second coupling portion of the coupler. The tongue-and-groove arrangement includes a set of angularly spaced apart grooves formed in an inner wall surface of the handle sleeve, and a radial tongue formed on an outer wall surface of the second coupling portion of the coupler to engage removably a selected one of the grooves when the handle sleeve is sleeved on the second coupling portion of the coupler.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional door lock;

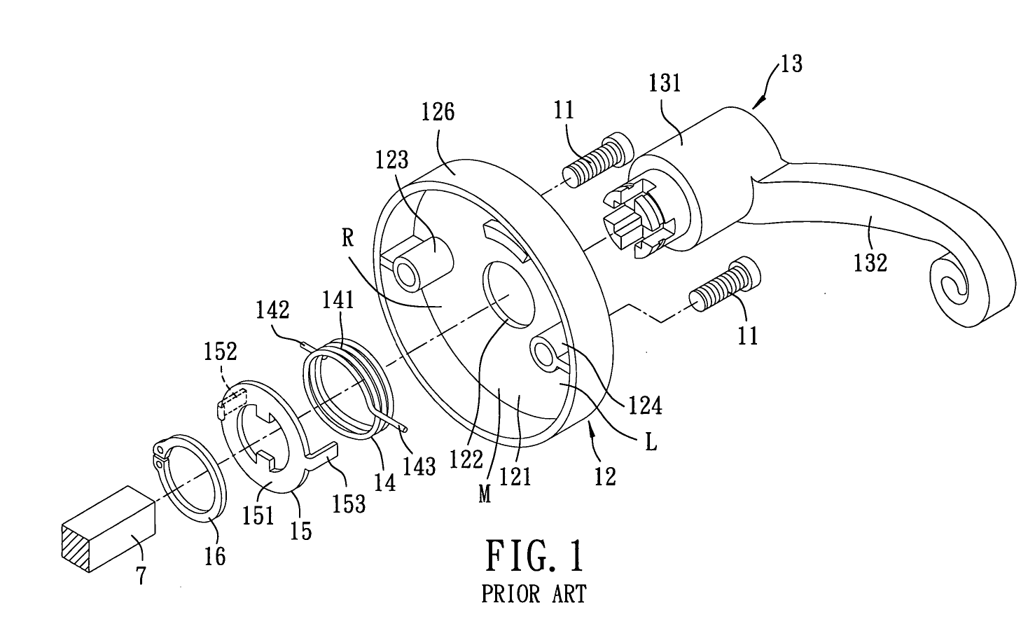

FIG. 2 is a schematic view to illustrate the conventional door lock when mounted on a door panel;

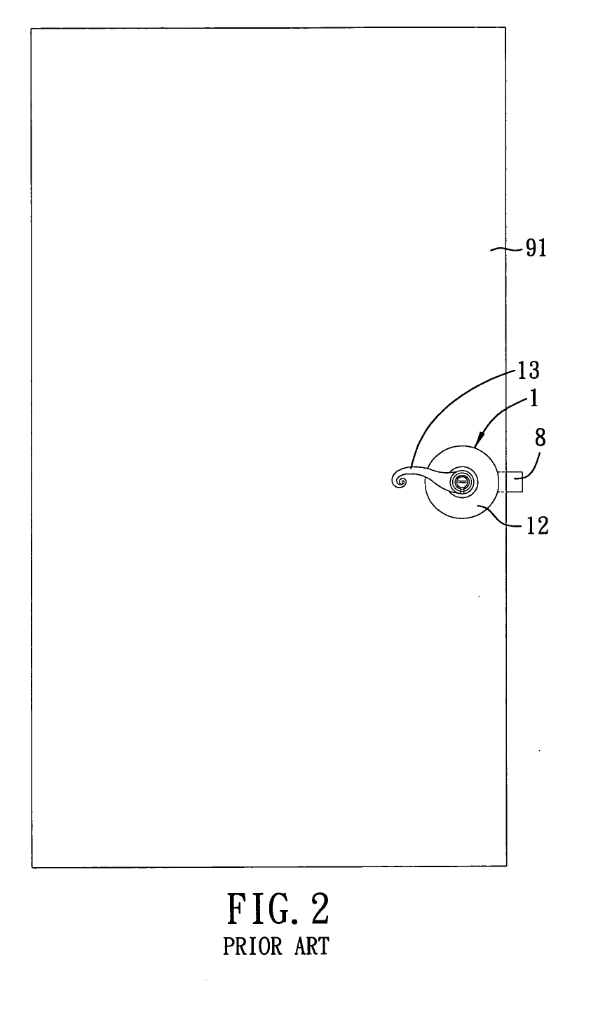

FIG. 3 is a schematic partly sectional view to illustrate a door handle of the conventional door lock when rotated from a first position to a second position;

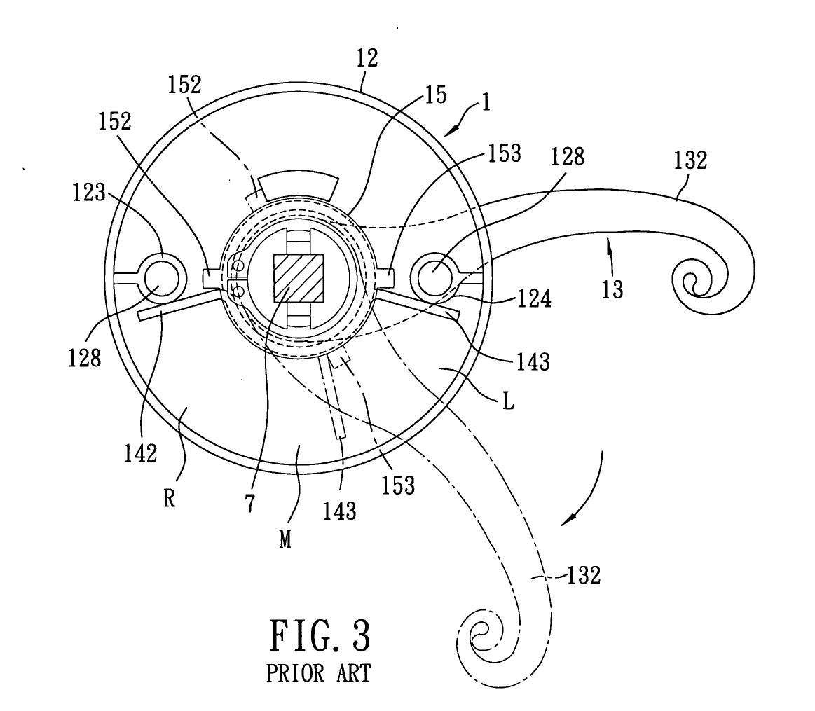

FIG. 4 is an exploded perspective view of the preferred embodiment of a door lock according to the present invention;

FIG. 5 is schematic sectional view of the preferred embodiment in an assembled state;

FIG. 6 is a schematic partly sectional view of the preferred embodiment when mounted on a right side of a door panel;

FIG. 7 is a schematic partly sectional view of the preferred embodiment to illustrate the door handle of the door lock when rotated from a first position to a second position; and

FIG. 8 is a schematic partly sectional view of the preferred embodiment when mounted on a left side of the door panel.

### DETAILED DESCRIPTION OF THE PREFERRED EMBODIMENT

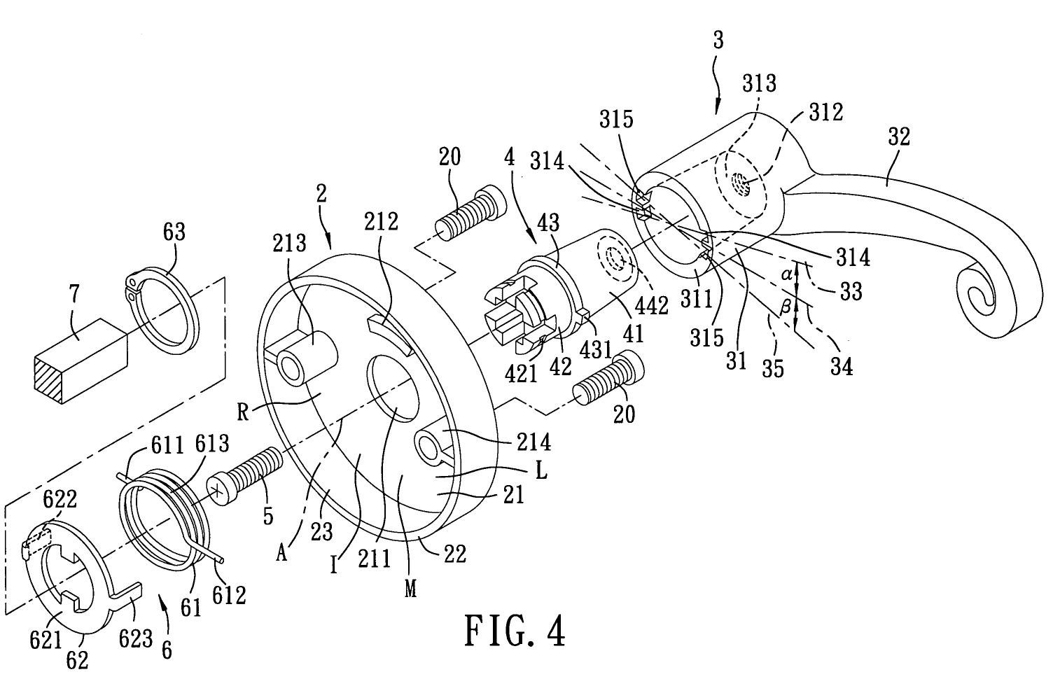

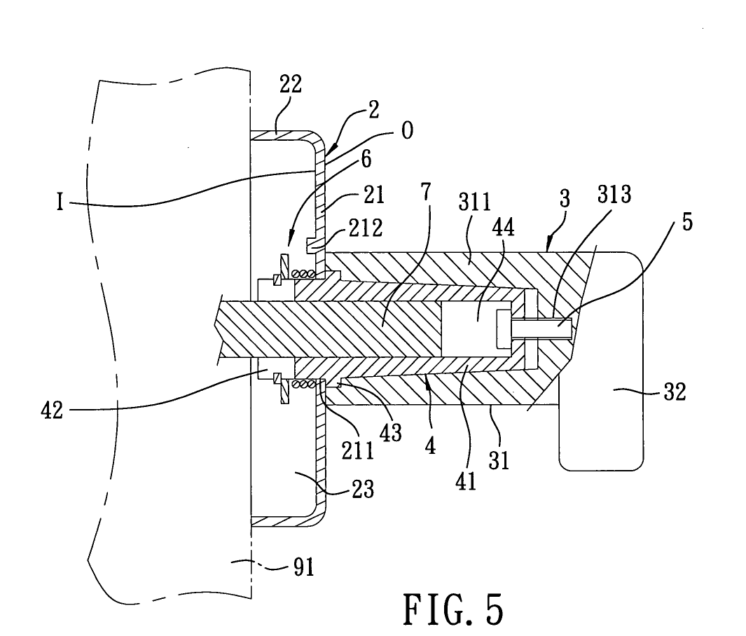

Referring to FIGS. 4 to 6, the preferred embodiment of a door lock for a door panel 91 according to the present invention is shown to include a lock housing 2, a latch bolt 8, an operating spindle 7, a coupler 4, a restoring mechanism 6, a door handle 3, fastening means, and a tongue-and-groove arrangement.

The lock housing 2 includes a first wall 21 that has inner and outer wall surfaces (I, O), and a second wall 22 that extends from a periphery of the first wall 21, that surrounds the inner wall surface (I) of the first wall 21, and that cooperates with the first wall 21 to define a mounting space 23. The first wall 21 of the lock housing 2 has left and right end portions (L, R), and a middle portion (M) disposed between the left and right end portions (L, R) of the first wall 21. The middle portion (M) of the first wall 21 is formed with a mounting hole 211 through the inner and outer wall surfaces (I, O). The mounting hole 211 has a hole axis (A) that lies in a horizontal plane 34. The lock housing 2 is adapted to be mounted on the door panel 91. In particular, each of the left and right end portions (L, R) of the first wall 21 of the lock housing 2 is formed with a fastener hole 215 through the inner and outer wall surfaces (I, O). Left and right screw hole-defining walls 214, 213, each of which is disposed in the mounting space 23, extend from the inner wall surface (I) of the first wall 21, and respectively define a screw hole that is aligned with a corresponding one of the fastener holes 215. A pair of screw fasteners 20, each of which is inserted through a respective one of the fastener holes 215 and a respective one of the screw holes, are threaded into the door panel 91.

The latch bolt 8 is adapted to be mounted on the door panel 91, is conventional is construction, and is operable for movement between a latching position, where the latch bolt 8 is extended relative to the door panel 91, and an unlatching position, where the latch bolt 8 is retracted relative to the door panel 91.

The operating spindle 7 is coupled to the latch bolt 8, is conventional in construction, and is rotatable between a first angular position, where the latch bolt 8 is at the latching position, and a second angular position, where the latch bolt 8 is at the unlatching position.

The coupler 4 is mounted rotatably on the lock housing 2, and is capable of driving rotation of the operating spindle 7 between the first and second angular positions. In particular, the coupler 4 includes a first coupling portion 42 that extends into the mounting space 23 of the lock housing 2 through the mounting hole 211 and that is coupled to the latch bolt 8, and a second coupling portion 41 that is opposite to the first coupling portion 42 and that is disposed externally of the lock housing 2. In this embodiment, the second coupling portion 41 of the coupler 4 has a circular cross-section. An annular abutting shoulder 43 is provided on an outer wall surface of the second coupling portion 41 of the coupler 4 to abut against the outer wall surface (O) of the first wall 21 of the lock housing 2.

The restoring mechanism 6 serves to bias the coupler 4 to rotate the operating spindle 7 from the second angular position to the first angular position. In particular, the restoring mechanism 6 includes a torsion spring 61 that has a coil portion 613, and a pair of opposite spring ends 612, 611. The torsion spring 61 is mounted in the lock housing 2 such that the coil portion 613 is sleeved on the first coupling portion 42 of the coupler 4 and abuts against the inner wall surface (I) of the first wall 21, and such that the spring ends 612, 611 are respectively disposed under the left and right screw hole-defining walls 214, 213. The coupler 4 includes an actuating ring 62 that has a ring portion 621, and a pair of diametrically opposite arms 623, 622. The actuating ring 62 is mounted in the mounting space 23 of the lock housing 2 such that the ring portion 621 is sleeved securely and co-rotatably on the first coupling portion 42 of the coupler 4 and abuts against the coil portion 613 of the torsion spring 61, and such that the arms 623, 622 are respectively disposed above the spring ends 612, 611 of the torsion spring 61. The first coupling portion 42 of the coupler 4 is formed with an annular groove 421. The restoring mechanism 6 further includes a snap ring 63 that is fitted in the annular groove 421 and that abuts against the ring portion 621 of the actuating ring 62 so as to retain the torsion spring 61 and the actuating ring 62 on the first coupling portion 42 of the coupler 4.

The door handle 3 includes a handle sleeve 31 that is sleeved fittingly and removably on the second coupling portion 41 of the coupler 4, and a lever 32 that extends outwardly and radially from the handle sleeve 31. In particular, the handle sleeve 31 of the door handle 3 includes a base wall 313, and a surrounding wall 311 that extends from a periphery of the base wall 313. It is noted that the second coupling portion 41 of the coupler 4 has a frustoconical shape. As such, the handle sleeve 31 of the door handle 3 can be conveniently sleeved on the second coupling portion 41 of the coupler 4.

The fastening means serves to fasten removably the handle sleeve 31 of the door handle 3 on the second coupling portion 41 of the coupler 4. In particular, the fastening means includes a screw hole 442 formed through the second coupling portion 41 of the coupler 4, a threaded hole 312 formed in the base wall 313 of the handle sleeve 31 of the door handle 3, and a screw fastener 5 that is inserted through the screw hole 442 and that is threaded into the threaded hole 312.

The tongue-and-groove arrangement includes a pair of diametrically opposite first grooves 314 formed in an inner wall surface of the handle sleeve 31, a pair of diametrically opposite second grooves 315 formed in the inner wall surface of the handle sleeve 31, and a pair of diametrically opposite radial tongues 431 (only one of the radial tongues 431 is visible in FIG. 4) formed on the annular abutting shoulder 43 provided on the outer wall surface of the second coupling portion 41 of the coupler 4. In this embodiment, the first grooves 314 are disposed such that a first imaginary line 33 interconnecting the first grooves 314 forms a first angle (α) with respect to the horizontal plane 34. The second grooves 315 are disposed such that a second imaginary line 35 interconnecting the second grooves 315 forms a second angle (β) with respect to the horizontal plane 34 and intersects the first imaginary line 33 at the hole axis (A). In this embodiment, the second angle (β) is equal to the first angle (α). Preferably, each of the first and second angles (α, β) ranges from 3 to 5 degrees.

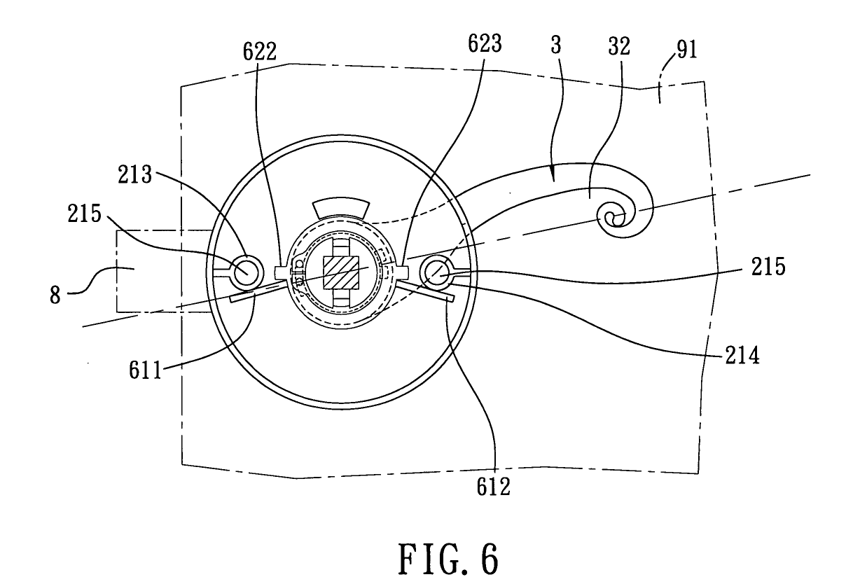

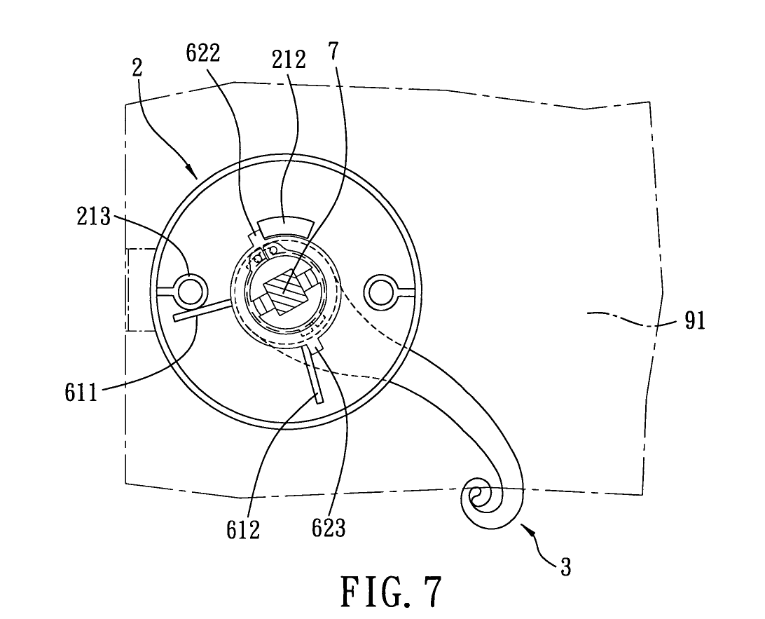

From the above description, when the door lock is mounted on the right side of the door panel 91, as illustrated in FIG. 6, the handle sleeve 31 of the door handle 3 is sleeved on the second coupling portion 41 of the coupler 4 such that the radial tongues 431 engage the first grooves 314. As such, when the operating spindle 7 is at the first angular position, the lever 32 extends leftwardly. At this time, the lever 32 is operable so as to rotate the handle sleeve 31 of the door handle 3 downwardly relative to the lock housing 2 such that the coupler 4 drives rotation of the operating spindle 7 from the first angular position to the second angular position. It is noted herein that during the operation, as illustrated in FIG. 7, the spring end 611 of the torsion spring 61 acts on the right screw hole-defining wall 213 of the lock housing 2, and the spring end 612 of the torsion spring 61 is acted upon by the arm 623 of the actuating ring 62 of the coupler 4.

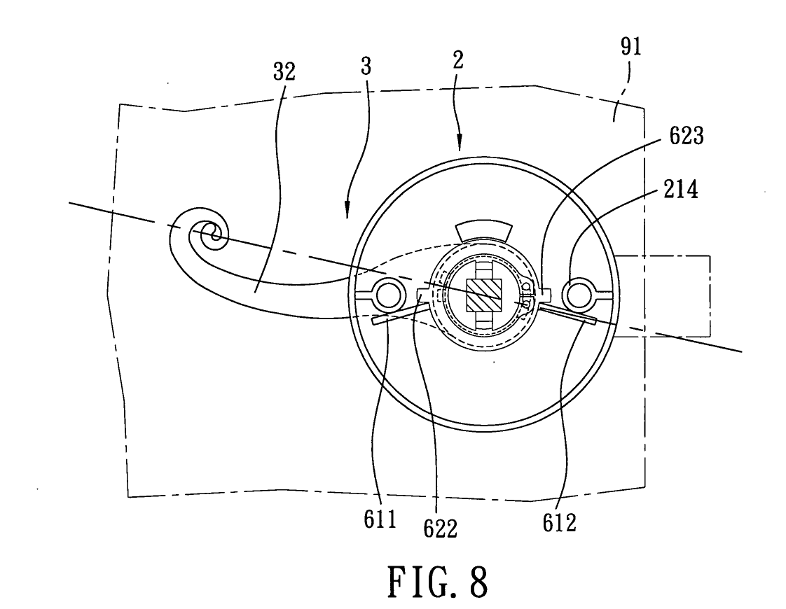

On the other hand, when the door lock is mounted on the left side of the door panel 91, as shown in FIG. 8, the handle sleeve 31 of the door handle 3 is sleeved on the second coupling portion 41 of the coupler 4 such that the radial tongues 431 engage the second grooves 315. As such, when the operating spindle 7 is at the first angular position, the lever 32 extends rightwardly. At this time, the lever 32 is operable so as to rotate the handle sleeve 31 of the door handle 3 downwardly relative to the lock housing 2 such that the coupler 4 drives rotation of the operating spindle 7 from the first angular position to the second angular position. It is noted herein that during the operation, the spring end 612 of the torsion spring 61 acts on the left screw hole-defining wall 214 of the lock housing 2, and the spring end 611 of the torsion spring 61 is acted upon by the arm 622 of the actuating ring 62 of the coupler 4.

The lock housing 2 further includes a limiting member 212 formed on the inner wall surface of the first wall 21 above the mounting hole 211. When the door lock is mounted on the right side of the door panel 91, and when the operating spindle 7 is in the second angular position, the arm 622 of the actuating ring 62 abuts against the limiting member 212 so as to limit further rotation of the coupler 4. Similarly, when the door lock is mounted on the left side of the door panel 91, and when the operating spindle 7 is in the second angular position, the arm 623 of the actuating ring 62 abuts against the limiting member 212 so as to limit further rotation of the coupler 4.

It has thus been shown that the door lock for a door panel 91 of this invention includes a lock housing 2, a coupler 4 mounted rotatably on the lock housing 2, and a door handle 3 coupled to the coupler 4. The coupler 4 is capable of driving rotation of an operating spindle 7 between first and second angular positions for moving a latch bolt 8 between latching and unlatching positions, respectively. The door handle 3 includes a handle sleeve 31 that is sleeved fittingly and removably on the coupler 4, and a lever 32 that extends outwardly and radially from the handle sleeve 31. The handle sleeve 31 is formed with a pair of diametrically opposite first grooves 314 and a pair of diametrically opposite second grooves 315. The coupler 4 is formed with a pair of diametrically radial tongues 431 that engage removably a selected pair of the first and second grooves 314, 315 when the handle sleeve 31 is sleeved on the coupler 4. As such, the lever 32 can be selectively oriented to extend leftwardly when the door lock is mounted on the right side of the door panel 91 and when the operating spindle 7 is at the first angular position, and rightwardly when the door lock is mounted on the left side of the door panel 91 and when the operating spindle 7 is at the first angular position. Moreover, the construction as such ensures downward operation of the lever 32 so as to rotate the handle sleeve 31 of the door handle 3 relative to the lock housing 2 such that coupler 4 drives rotation of the operating spindle 7 from the first angular position to the second angular position regardless of whether the door lock is mounted on the left or right side of the door panel 91 and without the need to reassemble the restoring mechanism 6. Further, since the imaginary line 33 (35) that interconnects the first grooves 314 (the second grooves 315) forms an angle α (β) with respect to the horizontal plane 34, when the door handle 3 is sleeved on the coupler 4 such that the radial tongues 431 engage the first grooves 314 (the second grooves 315), the lever 32 is kept in an upward slanting position to compensate for undesired positional deviation of the lever 32 due to eventual spring fatigue of the torsion spring 62.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A door lock for a door panel, said door lock comprising:
a lock housing adapted to be mounted on the door panel, and formed with a mounting hole that has a hole axis;
a latch bolt adapted to be mounted on the door panel, and operable for movement between a latching position, where said latch bolt is extended relative to the door panel, and an unlatching position, where said latch bolt is retracted relative to the door panel;
an operating spindle coupled to said latch bolt and rotatable between a first angular position, where said latch bolt is at the latching position, and a second angular position, where said latch bolt is at the unlatching position;
a coupler mounted rotatably on said lock housing, and including a first coupling portion that extends into said lock housing through said mounting hole and that is coupled to said latch bolt, and a second coupling portion that is opposite to said first coupling portion and that is disposed externally of said lock housing, said coupler being capable of driving rotation of said operating spindle between the first and second angular positions;
a restoring mechanism for biasing said coupler to rotate said operating spindle from the second angular position to the first angular position, said restoring mechanism including a torsion spring mounted in said lock housing, and having a first spring end acting on said lock housing, and a second spring end acted upon by said first coupling portion of said coupler;
a door handle including a handle sleeve that is sleeved fittingly and removably on said second coupling portion of said coupler, and a lever that extends outwardly and radially from said handle sleeve, said lever extending sidewardly when said operating spindle is at the first angular position, and being operable so as to rotate said door handle downwardly relative to said lock housing such that said coupler drives rotation of said operating spindle from the first angular position to the second angular position;
fastening means for fastening removably said handle sleeve of said door handle on said second coupling portion of said coupler; and
a tongue-and-groove arrangement including a set of angularly spaced apart grooves formed in an inner wall surface of said handle sleeve, and a radial tongue formed on an outer wall surface of said second coupling portion of said coupler to engage removably a selected one of said grooves when said handle sleeve is sleeved on said second coupling portion of said coupler.

2. The door lock as claimed in claim 1, wherein said second coupling portion of said coupler has a circular cross-section,
said handle sleeve of said door handle including a base wall, and a surrounding wall extending from a periphery of said base wall,
said fastening means including a screw hole formed through said second coupling portion of said coupler, a threaded hole formed in said base wall of said handle sleeve of said door handle, and a screw fastener that is inserted through said screw hole and that is threaded into said threaded hole.

3. The door lock as claimed in claim 1, wherein said second coupling portion of said coupler has a frustoconical shape.

4. The door lock as claimed in claim 1, wherein the set of angularly spaced apart grooves includes first and second grooves that are disposed on opposite sides with respect to the hole axis.

5. The door lock as claimed in claim 4, wherein the hole axis lies in a horizontal plane,
said first groove being disposed such that a first imaginary line radiating from the hole axis to said first groove forms a first angle with respect to the horizontal plane,
said second groove being disposed such that a second imaginary line radiating from the hole axis to said second groove forms a second angle with respect to the horizontal plane.

6. The door lock as claimed in claim 5, wherein the second angle is equal to the first angle.

7. The door lock as claimed in claim 5, wherein each of the first and second angles ranges from 3 to 5 degrees.
